(19) United States
(12) Patent Application Publication
(10) Pub. No.: US 2010/0236853 A1
(43) Pub. Date: Sep. 23, 2010

(54) BATTERY PACK WITH EXTENDED OPERATING TEMPERATURE RANGE

(76) Inventor: Dennis Kramer, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/408,203

(22) Filed: Mar. 20, 2009

(51) Int. Cl. B60K 11/04; F28D 15/00; H01M 10/50

(52) U.S. Cl. 180/68.4; 165/104.31; 429/120

(57) ABSTRACT

A battery pack includes a plurality of battery modules mounted within a casing. A liquid heat exchanger and at least one fan are both mounted at a position within the casing such that they are intermediate the plurality of battery modules. An electronic driveline incorporating a battery pack, and a method of operating a battery pack are also disclosed and claimed.

### BACKGROUND OF THE INVENTION

This application relates to a multi-cell battery pack for use in vehicle applications, wherein a liquid heat exchanger and fan are placed at an intermediate location within the battery pack.

More and more vehicles are being provided with electric drivelines. Electric motors may be utilized to drive axles, actuate brakes, etc. Large battery packs are required for such systems.

Heavy vehicles have been proposed which include battery packs assembled from hundreds of individual cells and grouped in modules. Of course, it is desirable to maintain and extend the battery life for such vehicles. With so many cells in a pack, the currents, voltages, and temperature of the several cells should be kept as constant with each other as is possible to evenly load the cells. If the cells are unevenly loaded, early failure could result.

One challenge with maintaining constant load on the cells is that the temperature of the cells will increase with use. It is known to provide cooling structure for the cells. As an example, fans have been proposed to circulate cooling air over the battery packs. The fans have typically been provided on an outer edge of the battery packs.

With this location, the fans have not evenly cooled the cells, and thus the uneven load problem mentioned above occurs.

It is also known to incorporate a liquid heat exchanger to be associated with the cooling air flow. However, the heat exchangers and fans have not been able to provide uniform heating across the battery pack. In addition, these existing air systems can ingest dirty ambient air, and may require filters.

It is also known to use thermal electric cooling to cool the battery packs. However, these have proven expensive and inefficient.

### SUMMARY OF THE INVENTION

A battery pack includes a plurality of battery modules mounted within a casing. A liquid heat exchanger and at least one fan are both mounted at a position within the casing such that they are intermediate the plurality of battery modules.

An electronic driveline incorporating a battery pack, and a method of operating a battery pack are also disclosed and claimed.

These and other features of the present invention can be best understood from the following specification and drawings, the following of which is a brief description.

### BRIEF DESCRIPTION OF THE DRAWINGS

FIG. 1 shows a battery pack including a fan structure in a first condition.

FIG. 2 shows a subsequent condition.

### DETAILED DESCRIPTION OF THE PREFERRED EMBODIMENT

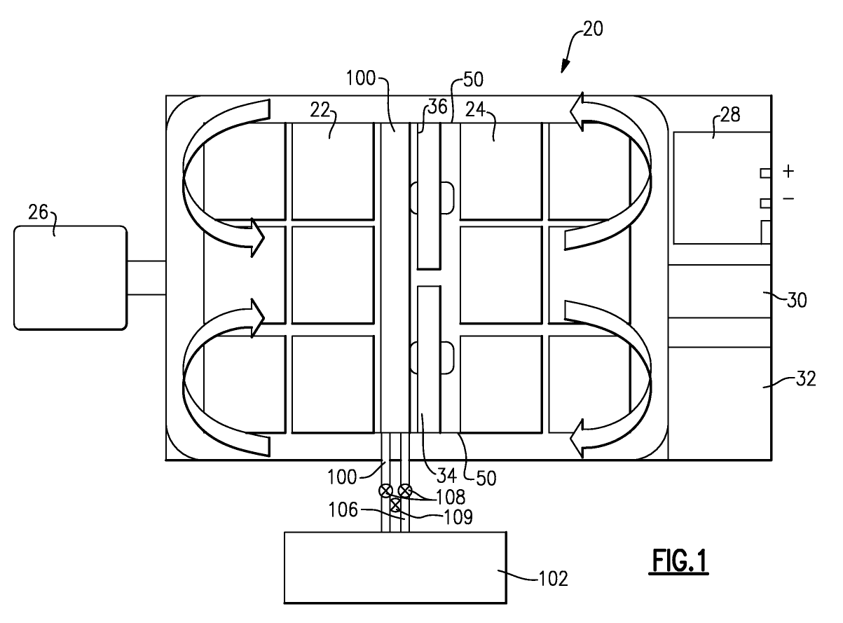

A battery pack 20 is illustrated in FIG. 1 having a plurality of multi-cell battery modules 22 and 24. As shown, the cell modules 22 and 24 are positioned on opposed sides of central fans 34 and 36.

The battery pack 20 drives electric motors 26, shown schematically. The electric motors 26 can be associated with heavy vehicle electric drive trains, and can include an axle drive, as an example. This portion of the invention may be as known in the art.

A battery management system 28 monitors voltage and provides feedback to a central vehicle control through an input/output connection.

A fan control 30 provides control signals to the fans 34 and 36. A disconnect 32 allows a manual electric disconnect, as is known.

A housing 50 surrounds the fans 34 and 36, and the modules 22 and 24.

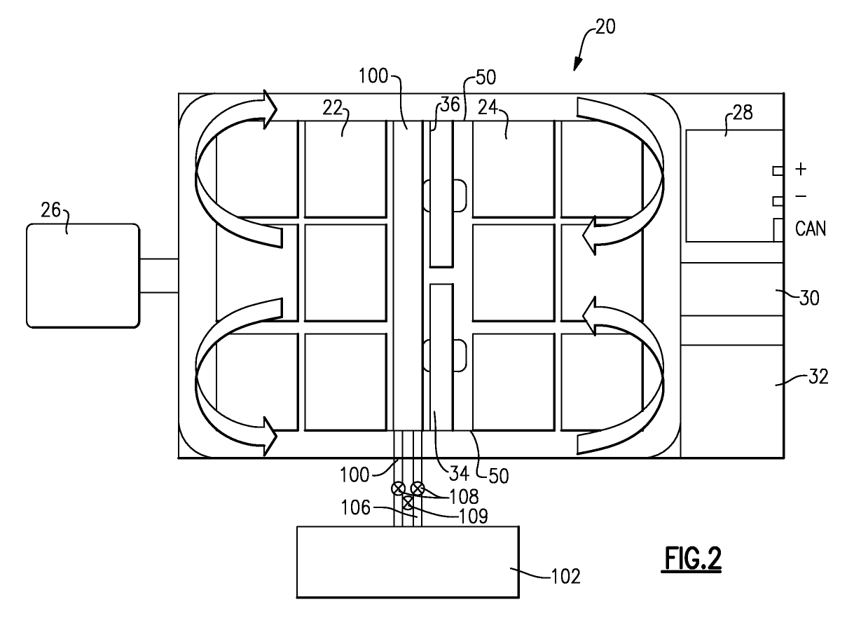

Due to the central location of the fans 34 and 36 between the modules 22 and 24, more even cooling will be provided than is the case in the prior art. While the fans 34 and 36 are shown at a central location with even numbers of modules 22 and 24 on both sides, other locations within the battery pack may come within the scope of this invention. In addition, the fan control 30 controls the fans 34 and 36 such that they flow in a first direction (left to right as shown in FIG. 1) for a period of time. After the passage of a period of time, the fan direction changes and the fans are reversed such that the airflow is from right to left, as shown in FIG. 2.

The airflow reversal time may be selected to be less than a cell thermal time constant of the multi-cell battery modules. The flow reversal cycles can be such that the direction changes at a time period less than one minute, and even less than every 30 seconds. In one disclosed embodiment, the reversal may occur every 10 seconds.

As shown, a liquid heat exchanger 100 may be incorporated at an intermediate location within the battery pack 20. As shown, it is aligned adjacent to the fans 34 and 36, and at a central location. A source of cooling fluid 102 is selectively connected to the heat exchanger 100. Shut-off valves 108 can selectively allow the provision of the cooling fluid to the heat exchanger, as is necessary. On the other hand, a bypass valve 109 can be opened with valves 108 shut when no additional cooling is required, and the fans can provide the cooling on their own.

The fans may use brushless, electronically commutated motors. A microprocessor control may be built into the fan drive.

The battery modules may be of the sort available from Energy Innovation Group (EiG), and as described at www.eigbattery.com. Of course, other battery modules would benefit from this invention.

In addition, co-pending and co-assigned patent applications entitled “Heavy Vehicle Battery Pack with Improved Cooling Scheme,” filed on even date herewith, and assigned Ser. No. ______, and “Battery Pack with Extended Operating Temperature Range,” filed on even date herewith, and assigned Ser. No. ______ should be studied as being somewhat related to the instant invention.

While the figures show a first layer of battery modules 22 and 24, and fans 34 and 36, it should be understood that there could be additional layers of each of these components extending into the plane of the paper. That is, there could be multiple layers within the actual total battery pack.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A battery pack comprising:
a plurality of battery modules mounted within a casing; and
a liquid heat exchanger and at least one fan, both mounted at a position within said casing such that they are intermediate the plurality of battery modules.

2. The battery pack as set forth in claim 1, wherein said at least one fan is mounted at a position within said casing such that airflow to said fan passes over some of said battery modules, and airflow downstream of said fan passes over others of said battery modules, and the airflow also passing over said heat exchanger.

3. The battery pack as set forth in claim 2, wherein said at least one fan is a reversible fan such that said fan pulls air in a first direction for a first period of time, and then reverses flow and pulls air in an opposed direction for a second period of time.

4. The battery pack as set forth in claim 3, wherein said first and second periods of time are selected to be less than one minute.

5. The battery pack as set forth in claim 2, wherein said at least one fan and said heat exchanger are positioned to be in a center of said battery modules.

6. The battery pack as set forth in claim 1, wherein a supply of cooling liquid is selectively connected to said heat exchanger.

7. The battery pack as set forth in claim 6, wherein valves are provided to selectively allow or bypass the flow of cooling fluid to the heat exchanger.

8. An electronic driveline for a vehicle comprising:
at least one electric motor, said at least one electric motor drawing power from a battery pack; and
a liquid heat exchanger and at least one fan, both mounted at a position within said casing such that they are intermediate the plurality of battery modules.

9. The electronic driveline as set forth in claim 7, wherein said at least one fan is mounted at a position within said casing such that airflow to said fan passes over some of said battery modules, and airflow downstream of said fan passes over others of said battery modules, and the airflow also passing over said heat exchanger.

10. The battery pack as set forth in claim 9, wherein said at least one fan and said heat exchanger are positioned to be in a center of said battery modules.

11. The electronic driveline as set forth in claim 8, wherein a supply of cooling liquid is selectively connected to said heat exchanger.

12. The electronic driveline as set forth in claim 8, wherein said at least one electric motor is for driving an axle of a vehicle.

13. A method of cooling a battery pack which includes a plurality of battery modules, comprising the steps of:
providing a fan and a heat exchanger at an intermediate location within the battery pack;
selectively delivering a cooling fluid to the heat exchange; and
pulling air over some of a plurality of battery modules, over said heat exchanger, and then over another group of said plurality of battery modules to cool the battery modules.

14. The method as set forth in claim 13, wherein a flow direction from said fan is periodically reversed.

15. The method as set forth in claim 13, wherein the flow of cooling fluid to said heat exchanger is selectively blocked.
